(19) United States
(12) Patent Application Publication
(10) Pub. No.: US 2006/0176378 A1
(43) Pub. Date: Aug. 10, 2006

(54) Digital camera with user identifying function

(75) Inventor: Teppei Okamoto, Saitama (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 11/347,382

(22) Filed: Feb. 6, 2006

(30) Foreign Application Priority Data
Feb. 7, 2005 (JP) P2005-030539

(51) Int. Cl. H04N 5/228

(52) U.S. Cl. 348/222.1

(57) ABSTRACT

A digital camera includes a user-register that registers a user who can use the digital camera as a registered user, and a user-judge that judges whether a user attempting to use the digital camera, is the registered user or not. The digital camera becomes operable when the user-judge judges the user attempting to use the digital camera is a registered user.

### BACKGROUND OF THE INVENTION

1. Field of the Invention

The present invention relates to a digital camera having a function for identifying a user.

2. Description of the Related Art

Generally, in cameras, parameters, photographing modes and so on can be set by users for adjusting various photographing functions, and they can be stored in the camera. On the other hand, in digital cameras, photographed images can be replayed on monitors.

### SUMMARY OF THE INVENTION

In case a digital camera is used by a plurality of users, parameters, or photographing modes set by a user can be changed by another user, and the changed parameters and so on can be updated and stored. In a similar case, image data which should be kept secret, may be replayed or deleted by users who were not the photographers.

Therefore, an objective of the present invention is to provide a digital camera which has a user identifying function, so that identified users can selectively use the digital camera.

A digital camera according to the present invention, includes a user-register that registers a user who can use the digital camera as a registered user, and a user-judge that judges whether a user attempting to use the digital camera is a registered user or not. The digital camera becomes operable when the user-judge judges the user attempting to use the digital camera is a registered user.

### BRIEF DESCRIPTION OF THE DRAWINGS

The present invention will be better understood from the description of the preferred embodiments of the invention set forth below together with the accompanying drawings, in which:

FIG. 1 is a front view of a digital camera of the first embodiment;

FIG. 2 is a rear view of the digital camera;

FIG. 3 is a view representing a screen displayed on an LCD monitor for inputting user identification codes;

FIG. 4 is a view representing a menu selection screen displayed on the LCD monitor;

FIG. 5 is a block diagram of the digital camera;

FIG. 6 is a conceptual view representing parameters stored in a flash memory for each registered user;

FIG. 7 is a conceptual view representing image data stored in a memory card for each registered user;

FIG. 8 is a flowchart representing a user identification routine to judge whether a user attempting to use the digital camera is a registered user or not in the first embodiment; and

FIG. 9 is a flowchart representing a user identification routine in the second embodiment.

### DESCRIPTION OF THE PREFERRED EMBODIMENTS

Hereinafter, the preferred embodiments of the present invention are described with reference to the attached drawings.

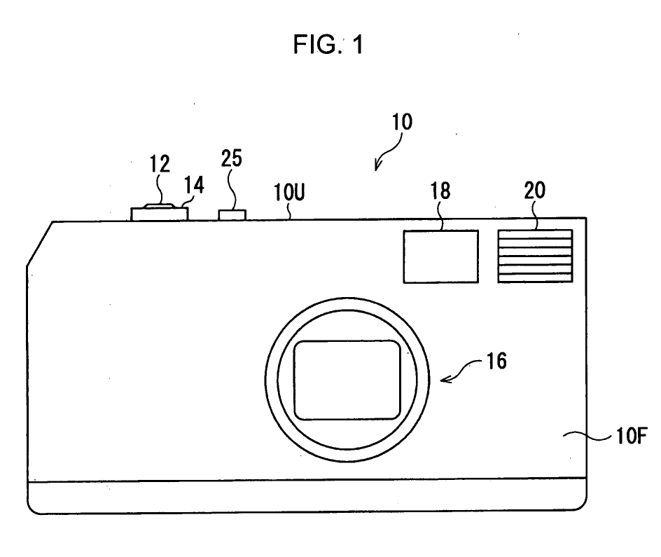

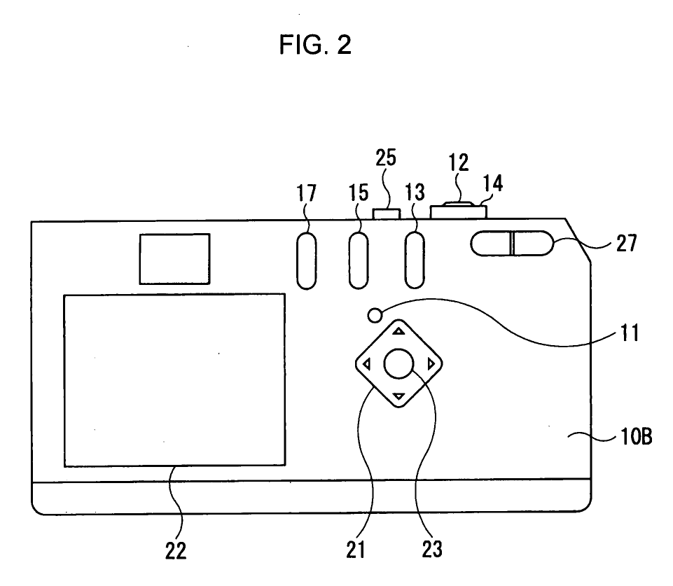

FIG. 1 is a front view of the digital camera of the first embodiment. FIG. 2 is a rear view of the digital camera.

On an upper surface 10U of the digital camera 10, a release button 12, a mode dial 14, and a power switch 25 are provided. On a front surface 10F of the digital camera 10, a photographing optical system 16 including a zoom lens, and a lighting device 20 are provided. Further, on a rear surface 10B of the digital camera 10, an LCD monitor 22 for displaying a subject image, buttons for executing predetermined operations, including a menu button 11, a focus setting button 13, a flash setting button 15, an image deleting button 17, a cross key 21, a zoom lever 27, and so on are provided (see FIG. 2).

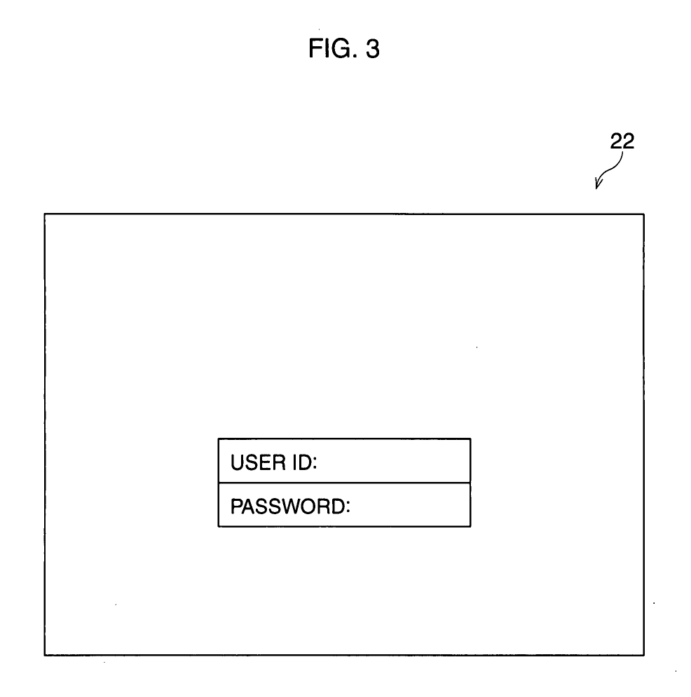

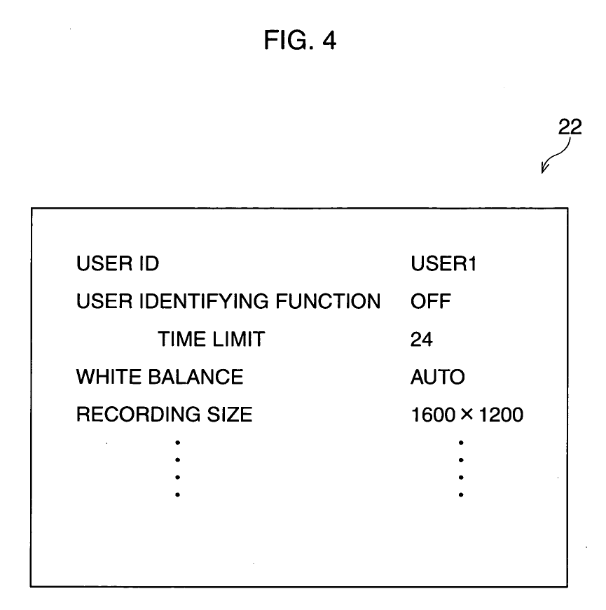

FIG. 3 is a view representing a screen displayed on the LCD monitor 22 for inputting user identification codes. FIG. 4 is a view representing a menu selection screen displayed on the LCD monitor 22.

When the digital camera 10 is used for the first time, an initial setting is carries out by the user. For the initial setting, predetermined screens are automatically displayed on the LCD monitor 22. One of the screens for initial setting, is for registering a user and is shown in FIG. 3. A user who uses the digital camera 10 for the first time, is registered as an owner user by inputting a user ID and a password to the screen by using the cross key 21, the OK button 23 and so on.

The owner user registered in the digital camera 10, can register other new users as regular users who are allowed to use the digital camera 10. In this case, the menu selection screen is displayed on the LCD monitor 22 by pressing the menu button 11, and then the screen for inputting user identification codes shown in FIG. 3 is selected and displayed. When a new user who is allowed to use the digital camera 10 inputs his user ID and a password, the user is registered as a regular user. As mentioned above, a user who can use the digital camera 10, is registered as an owner user who has predetermined authorities, or as a regular user who is permitted to use the digital camera 10 by the owner user. Hereinafter, the owner user and the regular user are called a registered user.

In the digital camera 10, a judgment execution mode where the user attempting to use the digital camera 10 is judged to be a registered user or not, and a judgment execution off mode where the user attempting to use the digital camera 10 is not judged to be a registered user or not, can be selected. That is, a registered user can set the digital camera 10 to judge the user when a usage is attempted at the next time after turning off the digital camera 10, by an operation of the power switch 25, or not to judge the user. This setting can be conducted by selecting an “ON” or “OFF” item of the “USER IDENTIFYING FUNCTION” on the menu selection screen (see FIG. 4). When the judgment execution mode is set, the screen for inputting user identification codes is automatically displayed on the LCD monitor 22 at the next starting time of the digital camera 10.

On the other hand, when the judgment execution off mode is set as shown in FIG. 4, the screen for inputting user identification codes is not typically displayed at the next starting time, therefore, the digital camera 10 becomes operable without inputting a user ID. However, not carrying out the user judgment for a long time is not desirable in terms of controlling the digital camera 10. Therefore, when the judgment execution off mode is set, a time limit for the judgment execution off mode can further set by the registered user. The time limit for the judgment execution off mode is selected from a predetermined plurality of candidate time limits, such as 24 hours and 48 hours, on the menu selection screen, and set by the registered user. The time limit may also be set to a desirable arbitrary time by the cross key 21 and so on.

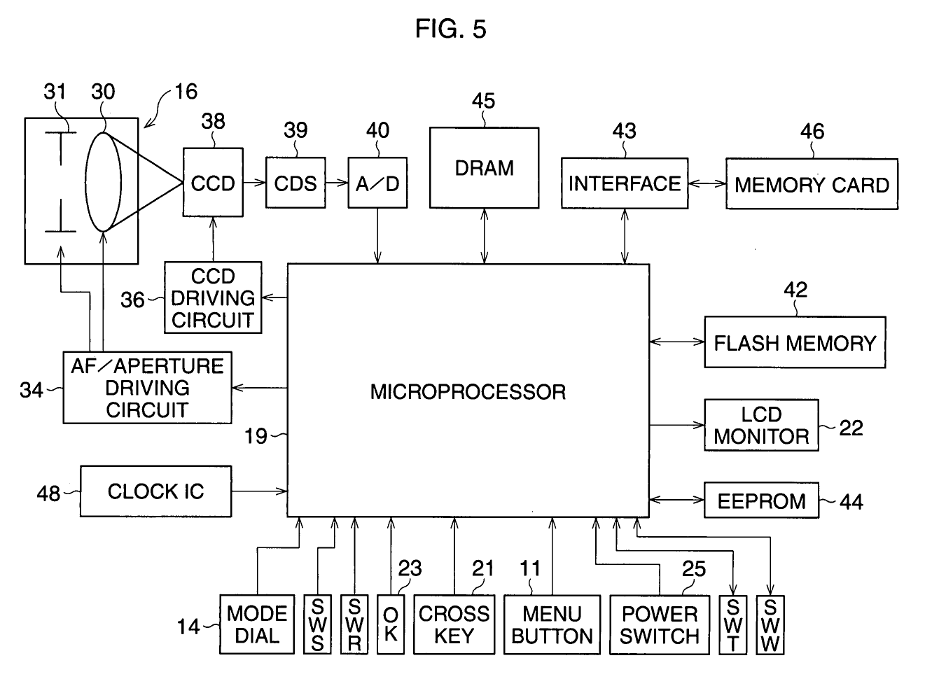

FIG. 5 is a block diagram of the digital camera 10.

In the digital camera 10, a microprocessor 19 for controlling all of the digital camera 10, is provided. Further, the digital camera 10 is provided with a flash memory 42 built-in for storing image data and so on, an EEPROM 44 for storing data for the signal processes carried out in the microprocessor 19, a clock IC 48 for time control, and so on. The mode dial 14, the power switch 25 and so on are connected to the microprocessor 19. When the power switch 25 is pressed by a user, the power of the digital camera 10 is turned on, and the microprocessor 19 starts.

In the judgment execution mode, the microprocessor 19 transmits predetermined signals to the LCD monitor 22, so that the screen for inputting user identification codes is displayed. When a user ID and a password are input, signals corresponding to the input information are transmitted to the microprocessor 19. In the microprocessor 19, whether the combination of the user ID and the password represented by the signals, matches one of that of a registered user previously stored in the flash memory 42, or not is judged. When it is judged that the combination of the user ID and the password matches that of the registered user, the digital camera 10 becomes operable. On the other hand, when it is judged that the combination of the user ID and the password does not match one that of a registered user, any operation, except for turning the power source off, and inputting user IDs and passwords is invalidated by the microprocessor 19, as long as a user ID and a pass word corresponding to the user ID are not input. At the time, a warning message is displayed on the LCD monitor 22 to inform the user attempting to use the digital camera 10 that the digital camera 10 will not become operable, based on the signals from the microprocessor 19.

On the other hand, in the judgment execution off mode, it is not judged whether the user attempting to use the digital camera 10 is a registered user or not, and the microprocessor 19 controls the digital camera 10 to be operable without inputting the user ID and so on.

The photographing mode for photographing a subject, and the replaying mode for replaying an image and so on, are selectively set by rotating the mode dial 14 to a predetermined position, and signals corresponding to the position of the mode dial 14 are transmitted to the microprocessor 19. The microprocessor 19 is connected to the menu button 11, the focus setting button 13, the flash setting button 15, the image deleting button 17, the cross key 21, a telephoto switch SWT for telephotographing and a wide angle switch SWW for wide angle photographing which is turned on by the operation of the zoom lever 27. When these buttons and switches are operated, signals corresponding to the operation are transmitted to the microprocessor 19. Users can select various parameters for photographing and so on by operating these buttons and switches. For example, desirable parameters for recording size (resolution of images), image quality, white balance, AF areas, photometry method, lighting of the lighting device 20 and so on, are selected from selectable parameters and used for photographing subjects. Note that the selection of the parameter, includes not only selecting index numbers, but also selecting a mode from the plurality of predetermined modes.

When the release button 12 is half depressed, a photometry-measuring switch SWS is turned on, and a subject distance is measured by a distance-measuring device (not shown), and photometry of a subject is measured by a photometry-measuring device (not shown). At the time, for example, when a spot measuring mode where only the center of the photographing area is an AF area, is set by an operation of the focus setting button 13, a subject distance is measured for only the center of the photographing area. Further, when a central weighting photometry mode is set as the photometry mode, photometry of a subject is weighted toward a part of the photometry area at the center of the photographing area. The obtained distance and photometry data are transmitted to the microprocessor 19. The microprocessor 19 controls an AF/aperture driving circuit 34 to adjust the position of a photographing lens 30 for focusing.

When the release button 12 is fully depressed, a release switch SWR is turned on. When the release switch SWR is turned on, an aperture 31 is opened by a predetermined amount by the AF/aperture driving circuit 34, and a shutter (not shown) is opened to the predetermined position for a predetermined time based on the control signals from the microprocessor 19. In the case an aperture value and a shutter speed are previously selected and set by the user, the aperture 31 and the shutter are driven according to each of the set parameters. And then a CCD 38 controlled by a CCD driving circuit 36 is exposed, so that image signals according to the image are generated in the CCD 38. When it is judged that illuminating a subject is necessary based on the distance and photometry data by the microprocessor 19, control signals are transmitted to a flash circuit (not shown) from the microprocessor 19, and the lighting device 20 emits illuminating light. At the time, when a compulsive lighting mode is previously set by an operation of a button for the lighting device 20, illuminating light is emitted regardless of the distance and photometry data, and when a light prohibiting mode is previously set, illuminating light is not emitted regardless of the distance and photometry data.

Image signals generated by the CCD 38 are processed to reduce noise at a CDS circuit 39 and are converted from analog to digital signals by an A/D converter 40. The digitalized image signals are transmitted to the microprocessor 19 after various processes such as white balance adjustment. The white balance is adjusted according to a mode selected by the user, such as an automatic mode, a sun light mode, and so on. The processed image signals are transmitted to an LCD driver (not shown) from the microprocessor 19, the LCD monitor 22 is driven based on the image signals, and a subject image is displayed on the LCD monitor 22.

Image data of the photographed subject image is temporally stored in a DRAM 45, further, stored in the flash memory 42 at the recording size previously selected, for example “1600×1200” pixels. The image data is transmitted to a memory card 46 inserted into the body of the digital camera 10 via an interface 43, and is also stored in the memory card 46. The image stored in the memory card 46 is replayed on the LCD monitor 22 when the replaying mode is selected by an operation of the mode dial 14. The image replayed on the LCD monitor 22, can be changed by an operation of the cross key 21. Further, stored image data can be deleted when depressing the image deleting button 17, under the control of the microprocessor 19.

The clock IC 48 is a circuit which controls time for any operation in the digital camera 10, such as for the photographing operation, and continuously transmits clock pulses to the microprocessor 19. Based on the clock pulses, an off mode time, which is a continuous time period the judgment execution off mode has been set, and which starts when the power switch of the digital camera 10 is turned off after the judgment execution off mode is set, is measured by the microprocessor 19. When the off mode time passes a predetermined time limit determined by the registered user, the judgment execution mode is alternatively set instead of the judgment execution off mode, under the control of the microprocessor 19. Therefore, after the judgment execution mode has been set, the screen for inputting a user identification code is automatically displayed on the LCD monitor 22.

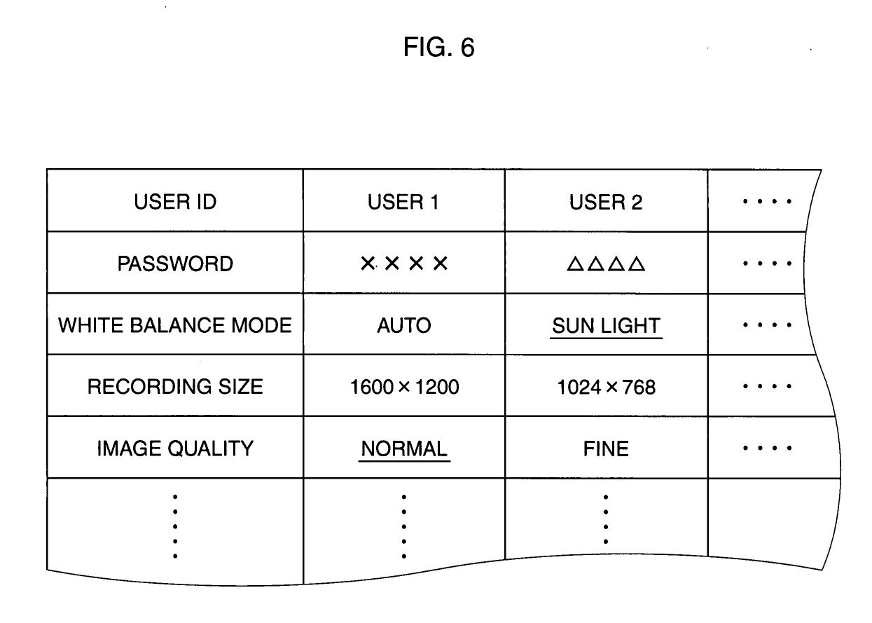

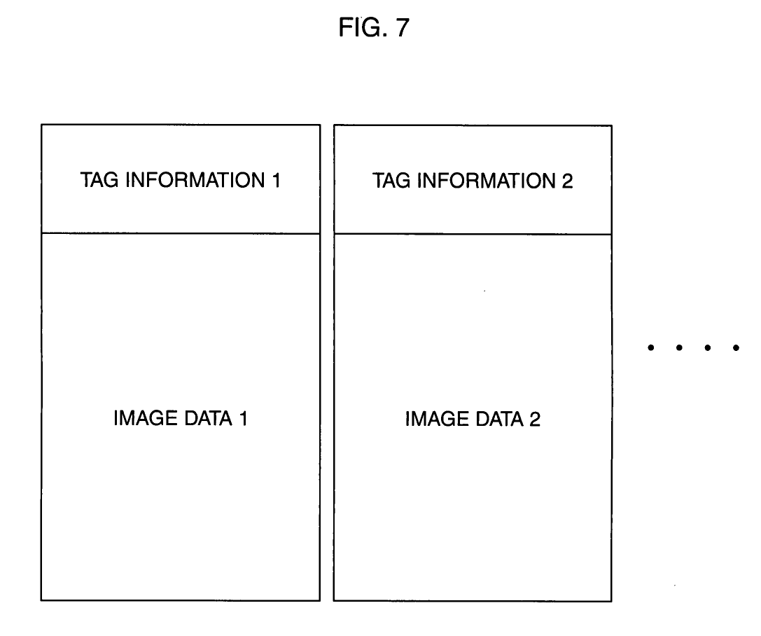

FIG. 6 is a conceptual view representing parameters stored in the flash memory 42 for each registered user. FIG. 7 is a conceptual view representing image data stored in the memory card 46 for each registered user.

When the user has finished using the digital camera 10 and the power source of the digital camera 10 is turned off, parameters which are set at that time, that is, the parameters which were selected last during the time the digital camera 10 has been working, are stored in the flash memory 42 to be related to the user ID of the registered user who was using the digital camera 10. Therefore, when the digital camera 10 starts, parameters used at the time of previous usage by the registered user who is now attempting to use the digital camera 10 and stored, are automatically read by the microprocessor 19 based on the user ID input by the registered user, and used for photographing. For example, in case a user now attempting to use the digital camera 10 is the “user 1”, the automatic mode of the white balance modes, and the recording size of “1600×1200” pixels are automatically set.

In case where no parameters have been selected, or a registered user uses the digital camera 10 for the first time, initial data for each of the parameters stored in the EEPROM 44 are automatically read and used. For example, the “normal mode” of the image quality modes, and the “sun light mode” of the white balance modes are initial data (see the under lined parts in FIG. 6).

Image data is stored in the memory card 46 to be related to tag information including user information representing which registered user is the photographer of the image, based on the user ID (see FIG. 7). That is, data for each image is stored corresponding to the user ID and the tag information including the user information representing which image can be replayed or deleted by the user in the memory card 46. On the other hand, in the flash memory 42, user IDs and parameters selected and set for the image are stored to be related each other (see FIG. 6). Therefore, information on whether the registered user who photographed the image, is an owner user or a regular user, is also stored in the flash memory 42.

When a user using the digital camera 10 is a regular user, in principle, only the image data of the images photographed by the regular user can be read from the memory card 46 and the images can be displayed on the LCD monitor 22. However, when a mode where not only the user who photographed the image but also the registered users are allowed to replay the image is previously set, the images photographed by all the registered users can be displayed on the LCD monitor 22. The mode where not only the photographer but also other registered users are allowed to replay the image, can be set by an operation of a button on the menu selection screen. Further, images photographed by cameras other than the digital camera 10 and stored in the memory card 46 without any user information, may also be replayed. When an owner user is using the digital camera 10, all images stored in the memory card 46 can be displayed on the LCD monitor 22, under the control of the microprocessor 19.

Similarly to replaying the image, in principle, a regular user can delete only the image data of the image photographed by himself, and an owner user can delete all of the image data, under the control of the microprocessor 19. When a mode where not only the user who photographed the image, but also registered users are allowed to delete the image is set previously to the photographing time, the image can be deleted by registered users other than the photographer. Note that when a user tries to delete an image which the user does not have permission to delete, a warning message informing the user of the matter, is displayed on the LCD monitor 22 based on control signals from the microprocessor 19.

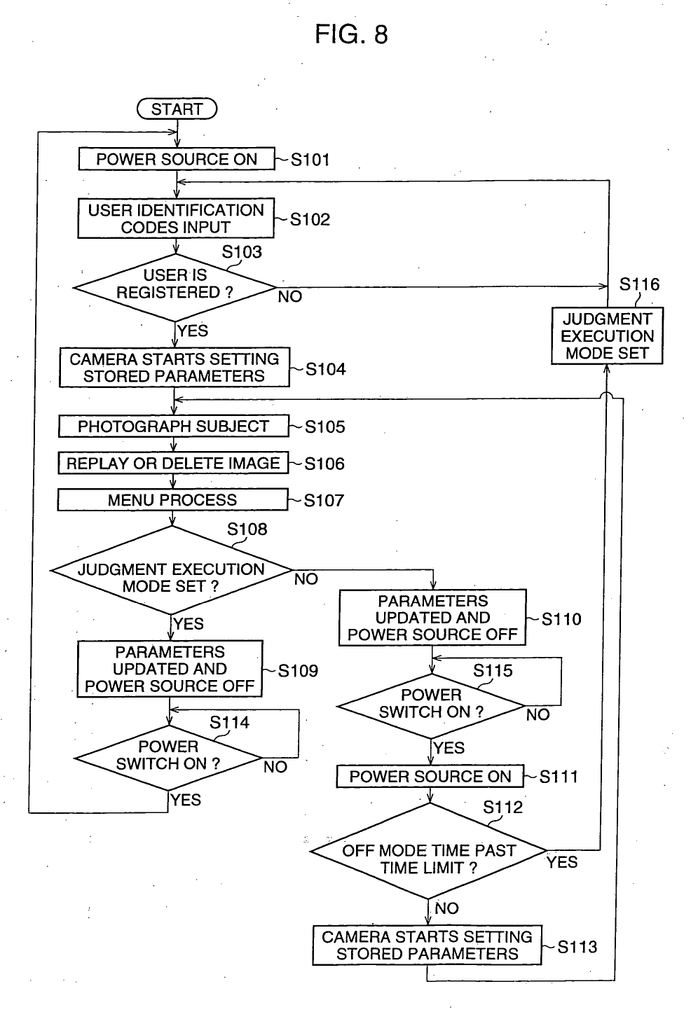

FIG. 8 is a flowchart representing a user identification routine to judge whether a user attempting to use the digital camera 10 is a registered user or not.

The user identification routine starts when a power switch 25 is turned on for initializing the digital camera 10. At step S101, the power source of the digital camera 10 is turned on and then the process proceeds to step S102. At step S102, the screen for inputting user identification codes is displayed, and a user ID for identifying the user and a password are input. At step S103, it is judged whether a user attempting to use the digital camera 10 is a registered user or not, that is, whether the combination of the input user ID and the password accords with a combination previously stored in the flash memory 42 or not, is judged by the microprocessor 19. When it is judged that the user attempting to use the digital camera 10 is a registered user, the process proceeds to step S104, and when it is judged that the user attempting to use the digital camera 10 is not a registered user, the process returns to step S102. Note that in case an owner user uses the digital camera 10 for the first time, a user ID and a password are input and registered at step S102, and the process proceeds to step S104.

At step S104, parameters set by the user currently using the digital camera 10 during a former usage and stored in the flash memory 42, are read and set, and the digital camera 10 starts. Note that in case an owner user uses the digital camera 10 for the first time and so on, initial data for each of the parameters is set. At step S105, a subject is photographed and the process proceeds to step S106. At step S106, an image is replayed, or deleted, according to the order from the registered user. At step S107, the processes according to one of the judgment execution mode and the judgment execution off mode selected by the user on the menu selection screen, are carried out, and the process proceeds to step S108.

At step S108, it is judged whether the judgment execution mode for judging a user attempting to use the digital camera 10 at the next starting time of the digital camera 10 is a registered user or not, is set by the current registered user, or not. When it is judged that the judgment execution mode is set at step S108, the process proceeds to step S109, and when it is judged that the judgment execution mode is not set, that is, the judgment execution off mode is set, the process proceeds to step S110. At step S109, the power switch 25 is operated, and the power source of the digital camera 10 is turned off after the parameters are updated, that is, parameters set by the registered user before the digital camera 10 is turned off, are stored. And then, the process proceeds to step S114. At step S114, it is judged whether the power switch 25 is turned on or not. When it is judged that the power switch 25 is turned on again, the process returns to step S101 and a user is identified at the next starting time of the digital camera 10 (steps S102 and S103), because the judgment execution mode is set.

On the other hand, at step S110, similarly to step S109, parameters are updated, the power source of the digital camera 10 is turned off, and the process proceeds to step S115. At step S115, similarly to step S114, it is judged whether the power switch 25 is turned on or not. When it is judged that the power switch 25 is turned on, the process proceeds to step S111.

At step S111, the power source of the digital camera 10 is turned on again, and the process proceeds to step S112. At step S112, it is judged whether a passing time from when the power source was turned off at step S110 to when the power source was turned on again at step S111, is longer than a predetermined time or not. That is, whether a continuous time period the judgment execution off mode has been set, has passed a predetermined time limit or not, is judged. When it is judged that the passing time is not longer than the predetermined time, the process proceeds to step S113. On the other hand, when it is judged that the passing time is longer than the predetermined time, the process proceeds to step S116. At step S113, stored parameters, that is, parameters updated at step S110 are read and the digital camera 10 starts without identifying the user, because the judgment execution off mode is set. And then, process returns to step S105.

On the other hand, at step S116, the judgment execution mode is set instead of the judgment execution off mode, and then the process returns to step S102 for the user identification.

In the embodiment mentioned above, the digital camera 10 having a user identifying function to identify a user is provided. Further, in the digital camera 10, parameters and images can be stored for each of the users, and the user identification mode is selectable in accordance with need. Therefore, parameters previously set by a user being changed by an other user by mistake, and image data which should be kept secret being replayed or deleted by mistake, can be prevented. Further, in the case where a same user frequently repeats operations for switching the power source of the digital camera 10 on and off in a short time, complicated operations are not required by setting the judgment execution off mode. In addition to this, usage by persons other than the registered users can be prevented because the judgment execution off mode is automatically switched to the judgment execution mode when a predetermined time passes.

Next, the second embodiment is explained, mainly in terms of the differences between the first embodiment. In the second embodiment, identifying a user or not at the next starting time of the digital camera 10, can be selected by choosing operations of the power switch 25 to turn the power source of digital camera 10 off, that is, simply depressing the power switch 25 (a first operation), or depressing it for several seconds (a second operation). When the power source of the digital camera 10 is turned off by the power switch 25 being simply depressed, signals to set the judgment execution mode are transmitted to the microprocessor 19, therefore, user identification is required for starting of the digital camera 10 at the next time. On the other hand, when the power source of the digital camera 10 is turned off by the power switch 25 being depressed for longer than a few seconds, signals to set the judgment execution off mode are transmitted to the microprocessor 19, therefore, user identification is not required for the next starting of the digital camera 10.

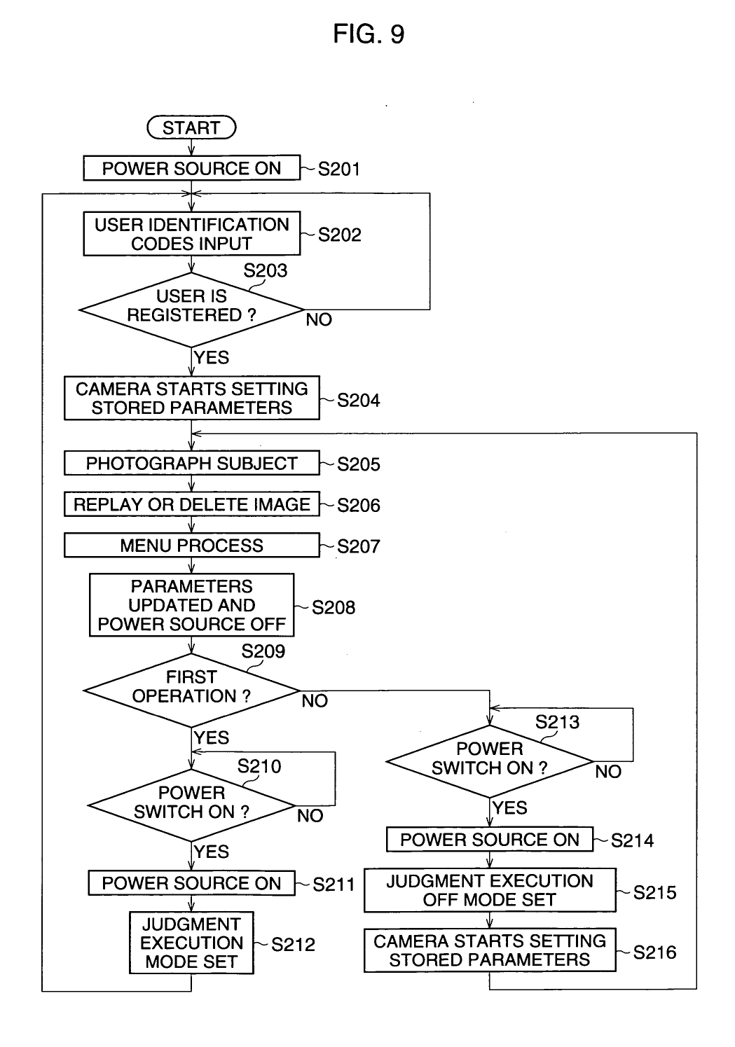

FIG. 9 is a flowchart representing a user identification routine in the second embodiment. Steps S201 to S207 correspond to steps S101-S107. At step S208, the power switch 25 is operated, and the power source of the digital camera 10 is turned off after the parameters are updated, and then, the process proceeds to step S209.

At step S209, it is judged whether the power source of the digital camera 10 is turned off by the first operation of the power switch 25, that is, whether the power switch 25 is depressed for a short time, or not, is judged. When it is judged that the power source is turned off by the first operation, the process proceeds to step S210, and when it is judged that the power source is not turned off by the first operation, that is, the power source is turned off by the second operation of the power switch 25 in which it is depressed for several seconds, the process proceeds to step S213.

At step S210, it is judged whether the power switch 25 is turned on or not. When it is judged that the power switch 25 is turned on, the process returns to step S211. At step S211, the power source of the digital camera 10 is turned on and the process proceeds to step S212. At step S212, the judgment execution mode is set and the process returns to step S202. Therefore, a user is identified at this starting time of the digital camera 10 (steps S202 and S203), because the judgment execution mode is set at step S212.

On the other hand, at step S213, it is judged whether the power switch 25 is turned on or not, similarly to step S210. When it is judged that the power switch 25 is turned on, the process proceeds to step S214. At step S214, the power source of the digital camera 10 is turned on and the process proceeds to step S215. At step S215, the judgment execution off mode is set and the process proceeds to step S216. At step S216, stored parameters, that is, parameters updated at step S208 are read and the digital camera 10 starts without identifying the user, because the judgment execution off mode is set at step S215. And then, process returns to step S205. Therefore, a user is not identified at this starting time of the digital camera 10.

Further, required operations for setting the judgment execution mode and judgment execution off mode can be reversed by operations on the menu selection screen. That is, the digital camera 10 can be set where the judgment execution off mode is selected by the power switch 25 being depressed simply, and the judgment execution mode is selected by the power switch 25 being depressed for longer than a few seconds, by operations on the menu selection screen.

Note that in the second embodiment, similarly to the first embodiment, the time limit for switching the judgment execution off mode to the judgment execution mode automatically, can be set before turning off the power source of the digital camera 10.

As mentioned above, in the second embodiment, the condition for selecting the judgment execution mode and the judgment execution off mode can be switched by simple operations.

The time limit for switching the judgment execution off mode to the judgment execution mode may not be set by an operation of the registered user, and the mode switching can occur anytime after passing a predetermined time, which is automatically set in the microprocessor 19.

The parameters and modes in these embodiments, are not limited to photographing, and can also be for image replaying and so on.

In terms of replaying and deleting images, the digital camera 10 may be set where only the user who photographed the images is permitted to replay and delete the images, based on the user information, regardless of the user being an owner user or a regular user.

The method for identifying a user attempting to use the digital camera 10, is not limited by inputting user identification codes. For example, a power switch which can detect the fingerprints of a user can be used. The digital camera 10 may be set by an owner user, to become operable without inputting passwords by the regular users, for the purpose of reducing complicated operations in case the digital camera 10 is lent to a regular user by the owner user.

The switching of the user identifying modes in the first and second embodiments, may be carried out by an operation on the menu selection screen.

The invention is not limited as described in the preferred embodiments, namely, various improvements and changes may be made to the present invention without departing from the spirit and scope thereof.

The present disclosure relates to subject matter contained in Japanese Patent Application No. 2005-030539 (filed on Feb. 7, 2005) which is expressly incorporated herein, by reference, in its entirety.

1. A digital camera comprising;
a user-register that registers a user who can use said digital camera as a registered user; and
a user-judge that judges whether a user attempting to use said digital camera, is said registered user or not;
wherein said digital camera becomes operable when said user-judge judges said user attempting to use said digital camera is said registered user.

2. The digital camera according to claim 1, further comprising,
an on-mode setter that sets a judgment execution mode where said user-judge judges whether said user attempting to use said digital camera, is said registered user or not; and
an off-mode setter that sets a judgment execution off mode where said user-judge does not judge whether said user attempting to use said digital camera, is said registered user or not;
wherein said digital camera becomes operable when said user-judge judges said user attempting to use said digital camera is said registered user in said judgment execution mode, and when said judgment execution off mode is set.

3. The digital camera according to claim 2, further comprising,
a timer that measures an off mode time which is a continuous time period said judgment execution off mode has been set;
wherein said on-mode setter sets said judgment execution mode when said off mode time passes a predetermined time limit for said off mode time.

4. The digital camera according to claim 2, wherein said off-mode setter sets said judgment execution off mode, by an operation of said registered user.

5. The digital camera according to claim 4, further comprising,
a timer that measures an off mode time which is a continuous time period said judgment execution off mode has been set; and
a time-limit setter that sets a time limit for said off mode time, by an operation of said registered user;
wherein said on-mode setter sets said judgment execution mode when said off mode time passes said time limit.

6. The digital camera according to claim 5, wherein said time-limit setter sets said time limit which is selected from a plurality of candidate time limits, by said registered user.

7. The digital camera according to claim 4, further comprising, a switch which can be operated by said registered user;
wherein said off-mode setter sets said judgment execution off mode, with a first operation of said switch by said registered user.

8. The digital camera according to claim 7, wherein said on-mode setter sets said judgment execution mode, with a second operation of said switch, being different from said first operation, by said registered user.

9. The digital camera according to claim 7, wherein said switch is a power switch for starting said digital camera.

10. The digital camera according to claim 1, further comprising,
a parameter recorder for recording a parameter which is selected by said registered user;
wherein said parameter and registered user information which indicates said registered user who selected said parameter, are recorded in said parameter recorder.

11. The digital camera according to claim 1, further comprising,
an image memory for storing a photographed image;
wherein said photographed image and registered user information which indicates said registered user who photographed said image, are stored in said image memory.

12. The digital camera according to claim 1, wherein said user-judge judges whether said user attempting to use said digital camera, is said registered user or not, based on an identification code input by said user attempting to use said digital camera.
